(19) United States
(12) Patent Application Publication
(10) Pub. No.: US 2015/0342152 A1
(43) Pub. Date: Dec. 3, 2015

(54) PORT AND PERCH INSERT FOR BIRD FEEDER

(71) Applicant: Graham Evans, Canterbury (GB)

(72) Inventors: Graham Evans, Canterbury (GB); Matthew John Wood, Herne Bay (GB)

(73) Assignee: GRAHAM EVANS

(21) Appl. No.: 14/722,359

(22) Filed: May 27, 2015

(30) Foreign Application Priority Data
May 27, 2014 (GB) 1409379.3

(51) Int. Cl. A01K 39/012; A01K 39/01

(52) U.S. Cl. CPC A01K 39/012; A01K 39/01

(57) ABSTRACT

A port and perch insert for fitting into an aperture in a wall of a container of a bird feeder comprises a two-part combination of a first part with a port having, a first engaging element to engage the container wall within the container and a second part in the form of a locking member engageable with the first part and having a second engaging element which engages with the container wall when the two parts are inserted and locked together. The first and second engaging elements between them retain the insert in engagement with the container wall in such a way that the second part must be disengaged from the first to enable both parts to be removed from the container wall. The second part suitably comprises a U-shaped perch section and a part-cylindrical recess which engages a correspondingly shaped surface on the first part, enabling it to pivot so that its engaging member engages in a slot of the container wall and the perch section fits within a similarly shaped perch section of the first part to form a U-shaped perch adjacent the port.

### BACKGROUND OF THE INVENTION

1. Field of the Invention

This invention relates to a bird feeder of the type comprising a container for bird food, the container having a wall with apertures therein in which are inserted ports usually with perches attached thereto, to give a bird access to food in the container through the port.

2. Description of the Prior Art

In most commercially available bird feeders, ports are retained in position in their apertures by interaction within the container with port members on the other side of the container or with internal fittings linking the port members to one another. A typical example can be seen in GB 2451062 A in which opposed pairs of port and perch inserts on opposite sides of the container interlock with one another and are retained by a central longitudinal locking pin. If the pin is withdrawn, all the port members can be removed from the container.

It would be advantageous if port members could be made independently insertable into and removable from their respective apertures without disturbing other port members. US 2013/0255582 A for example discloses a feeder in which each port member has flanges at its upper and lower ends to enable the port member to be retained in a wall aperture by means of a snap fit. Such an arrangement however carries the risk of breakage either of the small flanges themselves or of the edges of the apertures in the feeder wall when inserting or removing the port members.

### SUMMARY OF THE INVENTION

According to certain embodiments the present invention provides a port and perch insert for fitting into an aperture in the wall of a container of a bird feeder, the insert comprising a two-part combination of a first part with a port, having a first engaging element to engage the container wall within the container, and a second part locking in the form of a member engageable with the first part and having a second engaging element which engages within the container wall when the two parts are inserted and locked together, the first and second engaging elements between them retaining the insert in engagement with the container wall in such a way that the second part must be disengaged from the first to enable both parts to be removed from the container wall.

The first part of the combination preferably comprises a plate-shaped member to engage a container wall, with a port formed through the plate-shaped member. The second part preferably comprises a perch or part thereof and is engageable with the first part adjacent the port. The second part is preferably engageable with the first so as to be pivotable between a locking position in which its engagement member extends beyond the first part to engage in an aperture in the container wall and a release position in which the engagement member can be disengaged from the container wall. The second part is preferably configured to engage the first with a snap fit when in its locking position.

Preferred embodiments of the invention will now be described with reference to the accompanying drawings wherein:

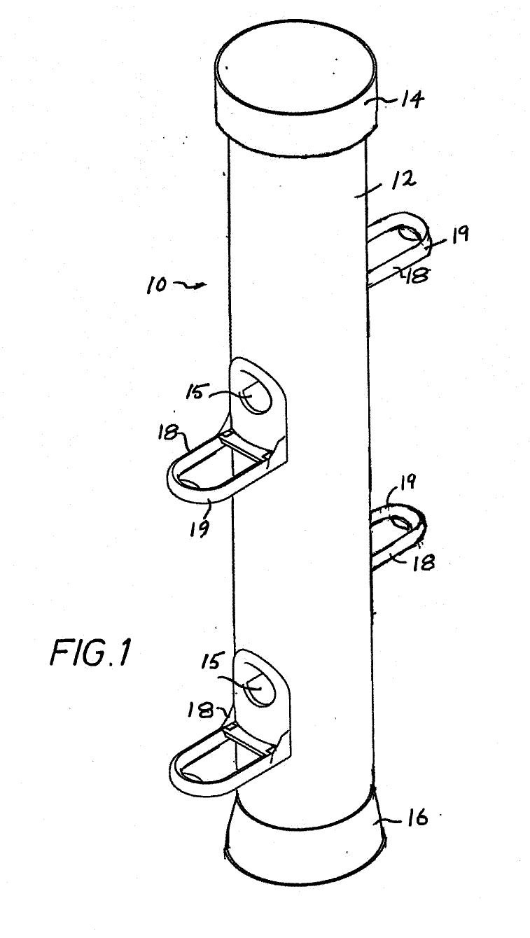

FIG. 1 is a perspective view of a bird feeder fitted with a plurality of port/perch combination inserts in accordance with the invention;

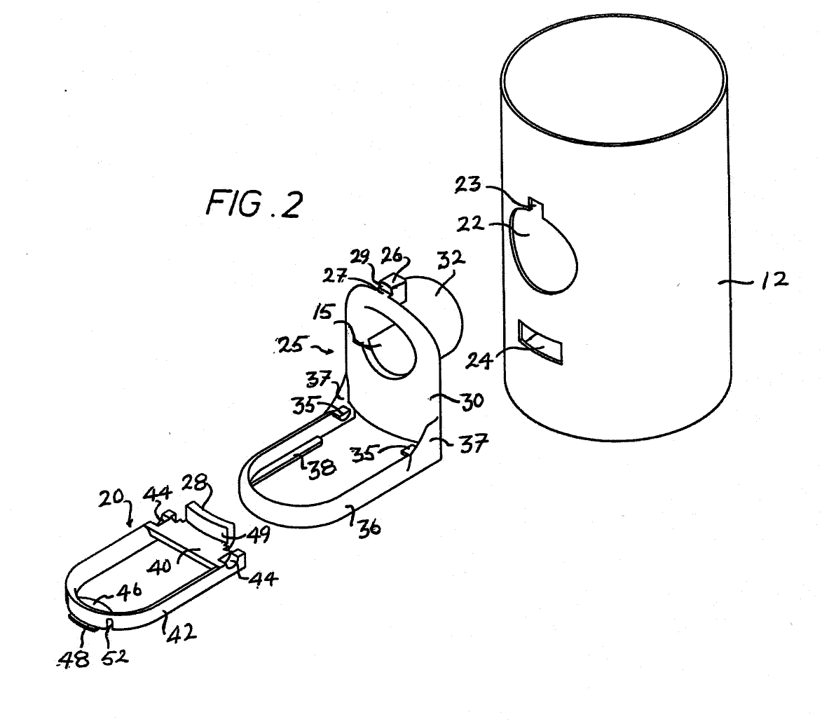

FIG. 2 shows a section of the bird feeder showing the apertures in the container wall, with the two parts of the port/perch combination insert of the invention shown separated;

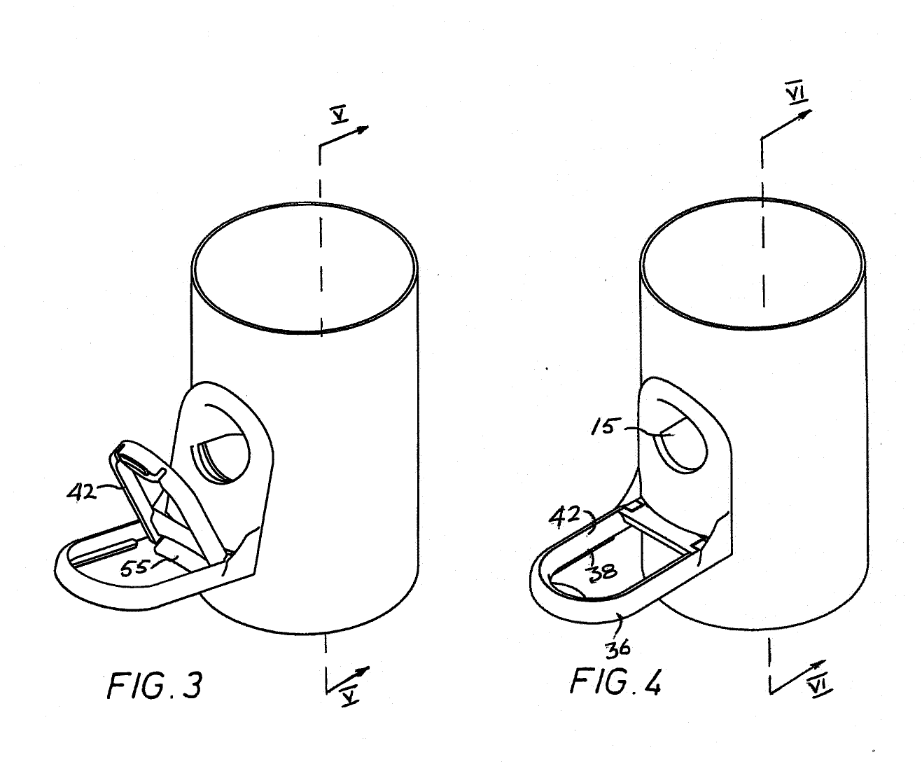

FIG. 3 shows a port/perch insert in accordance with the invention partly inserted into an aperture in a container wall;

FIG. 4 shows the port/perch insert with FIG. 3 in its fully inserted position;

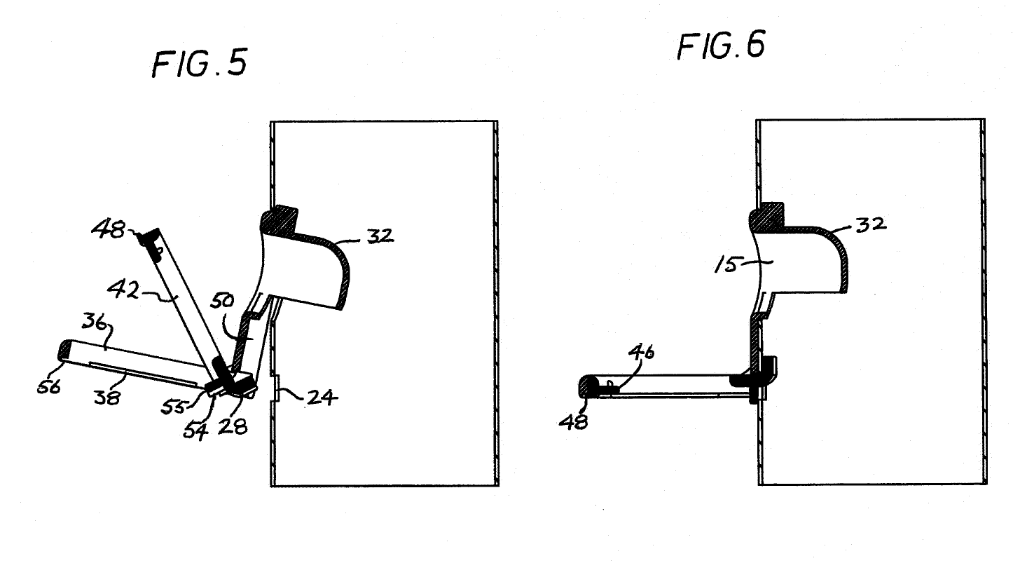

FIG. 5 is a cross-sectional view on the line V to V of FIG. 3; and

FIG. 6 is a cross-sectional view on the line VI to VI of FIG. 4.

### DETAILED DESCRIPTION OF THE PREFERRED EMBODIMENTS

Referring first to FIG. 1, a bird feeder generally indicated by 10 comprises a cylindrical tubular container 12, suitably of rigid transparent plastics material, fitted to a base 16 at its lower end and covered with a cap 14 at its upper end. Port/Perch inserts in accordance with the invention are fitted into apertures in the wall of the container 12, at different heights and on different sides. Each of these fittings includes a feeder port 15 and a U-shaped perch 19.

FIG. 2 shows, for simplicity, only a section of the cylindrical wall 12.

FIG. 2 also shows the port/perch insert 18 divided into a first part 25 comprising the port 15 and having a first engagement element 26, and a second part 20 serving as a locking part and having a second engagement element 28. The two parts of the insert are preferably made of metal or of a rigid plastics material, and in the latter case may suitably be injection moulded.

For each port/perch insert combination the cylindrical wall 12 of the container has a circular aperture 22 with a small rectangular cutout 23 in its upper edge. An elongate engagement slot 24 is positioned below the aperture 22 as shown in FIG. 2.

The first part 25 comprises a plate 30 of which the port 15 is formed and a U-shaped perch section 36 on the side of the plate 30 opposite the perch section is a hood 32, the shape of which can be most clearly seen in FIGS. 5 and 6.

The side of the plate 30 opposite that shown in FIG. 2 has a curved surface 50 shaped to engage the surface of the container 12 when the port is in position. This surface can be seen in FIG. 5.

Above the hood 32 is a first engagement member 26 having a surface 29 to engage an inner surface of the container as will be described below. This surface 29 is spaced from the surface 50 by a neck 27, by a distance approximately corresponding to the wall thickness of the container.

On the side of the port element facing outwards from the container, a U-shaped perch member 36 is connected to the plate 30 by a transverse engagement bar 35 with a flat front surface 37. The bottom edge 39 of the engagement bar 35 has a quarter-cylindrical surface, as seen in FIG. 5, shaped and dimensioned to fit into corresponding quarter-cylindrical recess of recesses 44 of the locking part 20.

The locking part 20 comprises a base part 40 from which extends a U-shaped perch section 42, dimensioned to fit snugly within the U-shaped section 36 of the first part 25 of the insert, and a top flange 38 shaped and dimensioned to engage a top surface 33 of the perch section 36 of the first part when the insert is assembled. At the end of the U-shaped perch section 42 remote from the base 40 is a locking flange 48 extending radially outwardly from the perch member 42 and connected to a finger plate 46 on the inside of the U. On each side of the flange 48 and finger plate 46 are small cut outs 52 which enable the end of the U-shaped perch member to bend slightly in turn enabling the flange 48 to fit in a recess 56 under the lower edge of the perch member 36 to engage with a snap fit when the combination is assembled.

On the side of the base 40 opposite the U-shaped perch member 42 is an engaging flange 28 having, on the side facing the U-shaped perch element 42 an engaging surface 49 of arcuate shape, with a radius of curvature approximately matching that of the inner surface of the container 12.

As can be seen in FIGS. 3 and 5, the locking element 42 has a downwardly extending flange 55 with an arcuate surface 54 with a radius of curvature approximately matching that of the outer surface of the container 12.

Assembly of the port/perch insert is as follows. As shown in FIGS. 3 and 5, the hood 32 of the port member 25 is inserted through aperture 22 and pushed upwards so that the neck section 27 engages in the cut out 23. The locking part 20 is placed in the position shown in FIGS. 3 and 5, with its semi-cylindrical recesses 44 receiving the lower edge of the engagement bar 35 so that it can pivot about the common axis of their respective part-cylindrical surfaces.

With the locking element raised as shown in FIGS. 3 and 5, the assembly can be pivoted downwardly about the first engagement element 26 so that the engaging flange 28 passes through the slot 24 and the surface 50 of the plate 30 engages the outer surface of the container. The locking part 20 can then be pivoted downwards until its flange 38 rests on the top surface 33 of U-shaped perch element 36 and its locking flange 48 engages with a snap fit in a recess 56 in the underside of the end of the U-shaped perch element 36. In this position the surface 49 of the engaging member engages the cylindrical inner surface of the container.

The assembled position is shown in FIGS. 4 and 6. The engaging surface 29 of the engaging member 26 bears against the inner surface of the container above the cut out 23 and the engaging surface 28 of locking member 26 bears against the inner surface of the container, while the surface 50 of the port member and surface 54 of the flange 55 of the locking member bear against the outer surface of the container. The port/perch assembly is thus firmly locked in position without the need for any internal locking mechanism separate from the port/perch insert itself.

In the assembled position shown in FIGS. 4 and 6, the perch elements 36, 42 together form a U-shaped perch from which birds can access the inside of the feeder through the port 15. The hood 32 prevents the contents of the container, typically a mixture of seeds, from flowing out of the port while allowing birds access to the contents below the hood.

To remove the port/perch assembly, the finger tab 46 can be pulled slightly upwards so that the locking flange 48 disengages from the recess 56. Swinging the locking member upwards and clockwise as shown in FIGS. 5 and 6, the engaging flange 28 can be pulled out of the slot 24, thereby enabling the port member 25 to be removed from the aperture 22.

There can thus be provided a bird feeder with port/perch combinations that can easily be inserted and removed individually and independently of one another, without the need for any internal locking or retaining mechanism. Defective ports or perches can thus be individually replaced, possibly with ports and perches of different sizes and shapes, provided the parts engaging the container are the same. Cleaning of the feeder and of the various inserts is also facilitated.

What is claimed is:

1. A port and perch insert for fitting into a first aperture in the wall of a container of a bird feeder, comprising a two-part combination of a first part with a port, having a first engaging element to engage the container wall within the container and a second part in the form of a locking member engageable with the first part and having a second engaging element which-engages within the container wall when the two parts are inserted and locked together, the first and second engaging elements between them retaining the insert in engagement with the container wall in such a way that the second part must be disengaged from the first to enable both parts to be removed from the container wall.

2. A two-part insert according to claim 1 wherein the first part of the combination comprises a plate-shaped member to engage a container wall, with a port formed through the plate-shaped member.

3. A two-part insert according to claim 1 wherein the second part is engageable with the first part so as to be pivotable between a locking position in which said second engagement member extends beyond the first part to engage in a second aperture in the container wall and a release position in which the engagement member can be disengaged from the container wall.

4. A two-part insert according to claim 1 wherein the second part is configured to engage the first with a snap fit when in its locking position.

5. A two-part insert according to claim 1 including a U-shaped perch.

6. A two-part insert according to claim 5 wherein the U-shaped perch is formed from a combination of respective U-shaped sections of the first and second parts.

7. A two-part insert according to claim 1 wherein the first part comprises a hood which is configured to protrude into the first aperture of the container and prevents the contents of the container from flowing out of the port and allows birds to access the contents below the hood.

8. A bird feeder having a container for bird food having at least a first aperture in a wall thereof, with a two-part port and perch insert according to claim 1 lockable into said at least one aperture.

9. A port and perch insert according to claim 8 wherein in the assembled configuration the engaging member has an engaging surface that bears against the inner surface of the container above the first aperture and the second engaging surface of the locking member bears against the inner surface of the container wall above a second aperture therein.
